(19) United States
(12) Patent Application Publication
(10) Pub. No.: US 2021/0400995 A1
(43) Pub. Date: Dec. 30, 2021

(54) PROTEIN-ENRICHED CHOCOLATE, AND METHOD FOR PRODUCING SAME

(71) Applicant: ROQUETTE FRERES, Lestrem (FR)

(72) Inventors: Pierre CHOROMANSKY, ROUBAIX (FR); Sylvie LAGACHE, MARCQ EN BAROEUL (FR); Camille RAIMBAULT, LAMBERSART (FR); Sophie GIRARD, ARRAS (FR)

(21) Appl. No.: 17/278,455

(22) PCT Filed: Sep. 25, 2019
(86) PCT No.: PCT/FR2019/052246

§ 371 Date: Mar. 22, 2021

(30) Foreign Application Priority Data
Sep. 27, 2018 (FR) 18 58925

(51) Int. Cl. A23G 1/44; A23G 1/00; A23G 1/36

(52) U.S. Cl. CPC A23G 1/44; A23V 2002/00; A23G 1/36; A23G 1/0026

(57) ABSTRACT

The invention relates to chocolate products having an increased protein content yet exhibiting an excellent organoleptic quality, in particular without sandy or pasty sensations when tasting. The invention also relates to a method for producing chocolate products of this type.

### SUBJECT OF THE INVENTION

The present invention relates to chocolate products that have an increased content of proteins and that nevertheless have an excellent organoleptic quality, in particular without a gritty or pasty sensation upon tasting. The present invention also relates to a process for manufacturing such types of chocolate products.

### PRIOR ART

Chocolate is a sweet confection produced from cocoa beans which are cleaned, fermented, roasted, crushed and ground to give the cocoa mass. Extracted from this cocoa mass by pressing are, on the one hand, the fat also referred to as cocoa butter and, on the other hand, the press cakes that are themselves used in the manufacture of cocoa powder.

The base constituents of milk chocolate are cocoa mass, cocoa butter, sugar and milk compounds in various forms: milk itself or the compounds resulting from the partial or complete dehydration of whole milk or of semi-skimmed or skimmed milk and optionally of cream, of partially or completely dehydrated cream, of butter or butterfat. In addition, lecithin and sometimes flavorings are added.

The production of chocolate requires a blending of the various ingredients which is carried out in a kneader at a temperature close to 50° C., followed by a grinding-refining that gives the chocolate its fineness, a conching and a tempering. Conching is still currently a very important step in chocolate manufacture. It makes it possible, inter alia, to obtain a reduction in the water content of the mass and promotes the formation of aromatic compounds resulting from the Maillard reaction, compounds that give particular sensory notes to the chocolate, and to distribute the fat around the dry phase in order to obtain a certain fluidity. Tempering consists in bringing the cocoa butter to its most stable crystalline form and gives the chocolate a glossy and smooth appearance, a hardness and a characteristic melting property, and also a longer shelf life. Typically tempering is the step of chocolate manufacture where the mass is heated and brought to the appropriate temperature (for example between 30° C. and 45° C.) allowing very fine crystallization of the chocolate giving it a glossy appearance, and a crunchy and melting texture.

European Directive 2000/36/EC grants the designation “chocolate” to a product obtained from cocoa products and sugars containing not less than 35% total dry cocoa solids, including not less than 18% cocoa butter and not less than 14% of dry nonfat cocoa.

It is nevertheless possible to optionally add other ingredients, such as milk or vegetable proteins, up to a maximum limit of 40% of the total dry weight of the chocolate as a finished product.

The enrichment of chocolate with proteins responds to an increasingly high nutritional expectation of consumers. Unfortunately, the conventional method of preparing chocolate described above enables protein-enriched chocolate to be obtained, but the organoleptic quality is greatly degraded compared to standard chocolate, in particular with the appearance of a grainy sensation upon tasting and a strong taste of proteins, particularly when using a soy protein.

The Applicant had already provided a protein-enriched chocolate in its patent EP 2 531 041. Example 1 thereof provides a chocolate enriched with 16.4% pea proteins. The organoleptic quality is considered to be excellent, in fact no difference between control and protein-enriched chocolate is observed. Unfortunately, when it is sought to increase this protein content above 30% proteins in order to lay claim to a “protein-enriched” product, experience shows us that a gritty sensation appears during tasting.

U.S. Pat. No. 4 493 853 proposes an enrichment by adding processed cheese, rich in proteins, in a weight ratio of 10/10 to 15/10. Here too the organoleptic quality is not lacking but the enrichment does not exceed 20% of proteins (cf. claim 13). This solution is also not suitable for the vegetarian or flexitarian population which is continually growing.

There is therefore an unmet need for those skilled in the art of confectionery to provide a chocolate enriched with more than 20% by dry weight of proteins or having more than 20% by dry weight of proteins, preferably vegetable proteins, having an organoleptic quality similar to standard chocolate, in particular a lack of a gritty or dry sensation upon tasting, and a process enabling it to be produced industrially.

### DESCRIPTION OF THE INVENTION

A first subject of this invention is therefore a protein-enriched chocolate containing between 20% and 40%, preferentially between 25% and 35% by dry weight of proteins relative to the total dry weight of the protein-enriched chocolate, of the finished product, preferentially vegetable proteins, more preferentially still pea proteins, characterized in that it has an excellent organoleptic quality, in particular without a gritty or pasty sensation upon tasting, with a limited presence of pea flavor.

In a preferred embodiment of the invention, the protein-enriched chocolate containing between 20% and 40%, preferentially between 25% and 35% by dry weight of proteins relative to the total dry weight of the finished product contains only vegetable proteins, more preferentially still only pea proteins.

In an alternative preferred mode, the protein-enriched chocolate containing between 20% and 40%, preferentially between 25% and 35% by dry weight of proteins relative to the total dry weight of the protein-enriched chocolate, of the finished product, contains a mixture of vegetable proteins and animal proteins, preferentially proteins of dairy origin, more preferentially still whey proteins. The vegetable proteins/animal proteins weight ratio is between 40% and 60%, preferentially between 45% and 55%.

The protein-enriched chocolate according to the invention is also characterized in that its Casson viscosity is less than 6 Pa·s, more particularly between 1 and 6 Pa·s, preferentially between 3 and 6 Pa·s.

A second subject of this invention is a process for obtaining protein-enriched chocolate as defined by the first subject of this invention, characterized in that it comprises the sequence of the steps:
1. producing a first mixture composed
   of a portion of the total amount of the cocoa butter used in the process;
   and of an amount of proteins so as to obtain a final content of proteins between 20% and 40%, preferentially between 25% and 35% by dry weight of proteins relative to the total dry weight of the protein-enriched chocolate, of the finished product
2. grinding the first mixture by passing through a mill suitable for refining chocolate, preferentially a two- or three-roll apparatus
3. producing a second mixture composed
   of an amount of chocolate representing between 30% and 50%, preferentially between 35% and 45% of the total dry weight of the protein-enriched chocolate
   and of the remaining amount of the cocoa butter, after using the amount from step 1
4. heating the two mixtures to about 60° C. so as to obtain the melting of the mixtures, two homogeneous mixtures
5. intimately mixing the two mixtures at 60° C., preferentially for a time of between 1 hour and 5 hours, more preferentially of between 2 h and 4 h, more preferentially still for 3.5 hours
6. cooling the temperature of the mixture obtained in step 5 to 50° C. and adding one or more emulsifiers, preferentially vegetable lecithin
7. tempering the mixture
8. pouring the mixture into the molds, i.e. implementation according to use, preferentially bar molding or enrobing

the total amount of cocoa butter being between 5% and 25% by weight relative to the total weight of the protein-enriched chocolate, preferentially between 8% and 21%, more preferentially still between 11% and 17%.

### DETAILED DESCRIPTION OF THE INVENTION

In the present invention, “chocolate” should be understood as a more or less sweet food produced from the cocoa bean. This is fermented, roasted and ground to form a liquid cocoa mass from which the fat, referred to as cocoa butter, is extracted. Chocolate consists of the mixture, in varying proportions, of cocoa mass, cocoa butter and sugar; optionally added to which are spices, such as vanilla, or vegetable fats. European Directive 2000/36/EC specifies the requirements in terms of composition in order to obtain the designation “chocolate” or “milk chocolate” in the territories of the European Community. The term “chocolate” in the present application includes not only chocolate, a product obtained from powdered cocoa products and sugars containing not less than 35% of total dry cocoa solids, including not less than 18% of cocoa butter and not less than 14% of dry nonfat cocoa, chocolate flakes, couverture chocolate, gianduja hazelnut chocolate, but also milk chocolate.

In the present invention, “protein” should be understood as the macromolecules formed from one or more polypeptide chains consisting of a sequence of amino acid residues linked together via peptide bonds. Proteins are of vegetable origin when they originate from the extraction of vegetable sources, for example leguminous plants. For the purposes of the present invention, the term “leguminous plants” is intended to mean any plants belonging to the families Caesalpiniaceae, Mimosaceae or Papilionaceae, such as alfalfa, clover, lupin, pea, bean, broad bean, faba bean or lentil.

The term “pea” is considered here in its broadest sense and includes in particular all wild-type varieties of “smooth pea” and “wrinkled pea” and all mutant varieties of “smooth pea” and “wrinkled pea”, irrespective of the uses for which said varieties are generally intended (food for human consumption, animal feed and/or other uses). In the present patent application, the term “pea” includes the varieties of pea belonging to the Pisum genus and more particularly to the sativum and aestivum species. Said mutant varieties are notably those known as “r mutants”, “rb mutants”, “rug 3 mutants”, “rug 4 mutants”, “rug 5 mutants” and “lam mutants” as described in the article by C-L Heydley et al., entitled “Developing novel pea starches”, Proceedings of the Symposium of the Industrial Biochemistry and Biotechnology Group of the

Biochemical Society, 1996, pages 77-87. Like all leguminous-plant proteins, pea proteins consist of three main classes of proteins: globulins, albumins and “insoluble” proteins.

The term “protein-enriched chocolate” in the present invention should be understood as a chocolate containing between 20% and 40%, preferentially between 25% and 35% by dry weight of proteins relative to the total dry weight of the protein-enriched chocolate, of the finished product.

The advantage of pea proteins lies in their good emulsifying capacities, their lack of allergenicity and their low cost, which makes them an economical functional ingredient. Furthermore, pea proteins contribute favorably to sustainable development and their carbon impact is very positive. This is because pea cultivation is environmentally friendly and does not require nitrogenous fertilizers, since the pea fixes atmospheric nitrogen.

In the specific context of pea proteins, the present invention relates more particularly to the globulins (approximately 50-60% by dry weight of pea proteins) and the albumins (20-25% by dry weight of pea proteins). Pea globulins are mainly subdivided into three subfamilies: legumins, vicilins and convicilins.

A first subject of this invention is therefore a protein-enriched chocolate containing between 20% and 40%, preferentially between 25% and 35% by dry weight of proteins relative to the total dry weight of the protein-enriched chocolate, of the finished product, preferentially vegetable proteins, more preferentially still pea proteins, characterized in that it has an excellent organoleptic quality, in particular without a gritty or pasty sensation upon tasting, with a limited presence of pea flavor.

In a preferred embodiment of the invention, the protein-enriched chocolate containing between 20% and 40%, preferentially between 25% and 35% by dry weight of proteins relative to the total dry weight of the protein-enriched chocolate, of the finished product contains only vegetable proteins, more preferentially still only pea proteins.

In an alternative preferred mode, the protein-enriched chocolate containing between 20% and 40%, preferentially between 25% and 35% by dry weight of proteins relative to the total dry weight of the protein-enriched chocolate, of the finished product, contains a mixture of vegetable proteins and animal proteins, preferentially proteins of dairy origin, more preferentially still whey proteins. The vegetable proteins/animal proteins weight ratio is between 40% and 60%, preferentially between 45% and 55%.

The term “organoleptic quality” will be understand as all the stimuli which relate to the sensory sphere of taste, flavor and odor following the tasting of a food.

When a chocolate containing between 20% and 40%, preferentially between 25% and 35% by dry weight of proteins relative to the total dry weight of the finished product is produced with conventional chocolate-making processes, i.e. by including the proteins from the start of the recipe, from the start of the process with all the other ingredients, a chocolate is obtained which, when it is tasted, has a poor organoleptic quality, in particular with a gritty or pasty sensation upon tasting, with a strong pea taste.

The chocolate produced by the process according to the invention has an excellent organoleptic quality, in particular without a gritty or pasty sensation upon tasting, with a limited presence of pea flavor. The process according to the invention enables the production of a chocolate which does not develop the appearance of a gritty sensation. This chocolate is therefore unique, and although being highly sought after by experts in the prior art, to the best of the applicant's knowledge no prior solution enabled it to be prepared.

This chocolate is obviously of interest for direct consumption but also for inclusion in various recipes such as drinks, cakes, cereal bars, coating chocolate and filling chocolate. This list is in no way limiting and the chocolate according to the invention allows its inclusion in all industrial applications, mainly food applications. The chocolate which is the subject of the present invention or obtained according to the process which is the subject of the present invention is dark chocolate, but may also be gianduja hazelnut chocolate or milk chocolate.

As long as at least 12% of the energy value of the protein-enriched chocolate which is the subject of the present invention or obtained according to the process which is the subject of the present invention is provided by proteins, this chocolate will be able to benefit from the claim “source of protein”. More particularly, as long as at least 20% of the energy value of the protein-enriched chocolate which is the subject of the present invention or obtained according to the process which is the subject of the present invention is provided by proteins, this chocolate will be able to benefit from the claim “protein-rich”.

The protein-enriched chocolate according to the invention is also characterized in that its Casson viscosity is less than 6 Pa·s, more particularly between 1 and 6 Pa·s, preferentially between 3 and 6 Pa·s.

The rheology of the chocolate is important in order to obtain high-quality products with a well-defined texture. The melted chocolate represents a suspension predominantly composed of solid particles of sugar and cocoa, reduced in size by refining by rollers to 30 μm, in a liquid matrix composed predominantly of cocoa butter. Rheologically, melted chocolate exhibits non-Newtonian behavior which is conventionally defined by a yield point and a viscosity. The yield point corresponds to the amount of energy required to initiate the flow of the chocolate and the viscosity is the resistance that a fluid puts up to the movement of its particles relative to one another. These properties depend both on the composition of the chocolate, and also on its manufacturing process. They obviously govern the ease of handling the chocolate (e.g. the transport through pipework or the pouring thereof into molds) but also its final intrinsic properties (e.g. melting in the mouth). As such, controlling the rheological properties of the chocolate is essential. In the confectionery reference book “Guide technologique de la confiserie industrielle” (Technological guide to industrial confectionery), there is thus a value of 1000 mPa·s, or 1Pa·s, as the viscosity value for a couverture chocolate containing 34-37% fat.

The reference methodology in chocolate making for measuring the viscosity is the Casson methodology. It is described in the ICA 46 standard published by the International Confectionery Association (ICA, formerly IOCCC). This suggests the combined use of rotating viscometers with concentric cylinders with measurement of the stress and viscosity at shear rates between 2 s⁻¹ and 50 s⁻¹ and downward curves preceded by a monitoring at 5 s⁻¹ of >5 min and the Casson regression equation.

A second subject of this invention is a process for obtaining protein-enriched chocolate as defined by the first subject of this invention. This process has the particular feature that the proteins are added to cocoa butter and then this mixture (proteins/cocoa butter), after having been ground and heated, is added to the other ingredients constituting the protein-enriched chocolate. More particularly, the process which is the subject of the present invention is characterized in that it consists of the sequence of the steps:
1. producing a first mixture composed
   of a portion of the total amount of the cocoa butter used in the process;
   and of an amount of proteins so as to obtain a final content of proteins between 20% and 40%, preferentially between 25% and 35% by dry weight of proteins relative to the total dry weight of the protein-enriched chocolate, of the finished product
2. grinding the first mixture by passing through a mill suitable for refining chocolate, preferentially a two- or three-roll apparatus
3. producing a second mixture composed
   of an amount of chocolate representing between 30% and 50%, preferentially between 35% and 45% of the total dry weight of the protein-enriched chocolate
   and of the remaining amount of the cocoa butter, after using the amount from step 1
4. heating the two mixtures to about 60° C. so as to obtain the melting of the mixtures, two homogeneous mixtures
5. intimately mixing the two mixtures at 60° C., preferentially for a time of between 1 hour and 5 hours, more preferentially of between 2 h and 4 h, more preferentially still for 3.5 hours
6. cooling the temperature of the mixture obtained in step 5 to 50° C. and adding one or more emulsifiers, preferentially vegetable lecithin
7. tempering the mixture
8. pouring the mixture into the molds, i.e. implementation according to use, preferentially bar molding or enrobing

the total amount of cocoa butter being between 5% and 25% by weight relative to the total weight of the protein-enriched chocolate, preferentially between 8% and 21%, more preferentially still between 11% and 17%.

All the technical characteristics described above for the various ingredients (nature and amounts) also apply to the process which is the subject of the present invention.

The partial amount of cocoa butter used in step 1 is preferentially between 10% and 90%, 15% and 85%, 20% and 80%, 25% and 75%, 30% and 70%, 35% and 65%, 40% and 60%, 45% and 55% of the total amount of cocoa butter used for the protein-enriched chocolate.

In a preferential embodiment, the proteins of step 1 are vegetable proteins, preferentially vegetable proteins derived from leguminous plants, more preferentially still proteins derived from peas.

The cocoa butter and protein mixture from step 1 is composed of 35% and 55% by weight of cocoa butter, preferentially between 40% and 50%, more preferentially between 45% and 50%, relative to the total weight of the mixture and an amount of proteins making it possible to obtain a final content of between 20% and 40%, preferentially between 25% and 35% by dry weight of proteins relative to the total dry weight of the enriched chocolate, i.e. of the finished product.

The term “cocoa butter” is understood here to mean the mixture of semi-solid and semi-liquid fat resulting from the extraction of cocoa beans.

Step 2 will allow fine grinding of the proteins by intimate mixing with the cocoa butter. Without being bound by any one theory, it appears that it is this intimate grinding of a mixture consisting only of proteins and cocoa butter which will then make it possible to obtain a chocolate which has an excellent organoleptic quality, in particular without a gritty or pasty sensation upon tasting, with a limited presence/limited taste of pea flavor.

The “three-roll” or “two-roll” devices are well known to those skilled in the art. Alternatively, use may be made of ball mills or any other tool which makes it possible to reduce the particle size of the insoluble part.

After mixing the ingredients, the pasty product is refined by grinding. The aim of this operation is to refine the solid particles so that they are no longer perceptible to the palate. It is conventionally recognized in the chocolate industry that a size of less than 60 μm, more preferentially still less than 30 μm, contributes to the elimination of the gritty sensation. This is true for standard chocolate manufacture, but it is no longer sufficient when it is desired to enrich the chocolate with more than 20% protein or when the finished chocolate product contains more than 30% by weight of protein. Depending on the devices, there may be from one to three passes through the three-roll device in order to obtain the desired particle size. By grinding the proteins and a portion of the cocoa butter separately, then the chocolate with the rest of the cocoa butter, before mixing these two mixtures, it is now possible to obtain a chocolate enriched with more than 20% of proteins which has an excellent organoleptic quality.

The chocolate used in the second mixture in step 3 is a commercial chocolate, or a chocolate which has been manufactured or which is manufactured at the same time. It can be either a dark chocolate or a milk chocolate.

By producing a mixture as carried out in the prior art (mixing of all the constituents), and despite passing through the three-roll mill, it will be impossible to obtain a standard sensory result with a protein-enriched recipe.

Step 3 consists of the production of a second mixture composed of an amount of chocolate representing between 30% and 50% of the weight of the final recipe, of the protein-enriched chocolate, preferentially between 35% and 45%, and the remaining amount of cocoa butter, after subtracting the amount used in step 1.

In an alternative method of this step, the ingredients necessary for the manufacture of the chocolate are used instead of a finished chocolate (commercial or prepared by us), after grinding on a grinder suitable for refining chocolate, preferentially a two- or three-roll device.

Step 4 consists of melting by heating the two preceding mixtures, with stirring in any receptacle suitable for this purpose, for example a thermostatically-controlled mixing bowl. The chocolate can be obtained commercially, preferentially a dark chocolate. The chocolate can also be manufactured, at the same time, according to the conventional chocolate-making procedures. It is important here never to directly introduce all or part of the proteins, at the risk of causing organoleptic degradation of the chocolate, particularly an appearance of a gritty or pasty sensation upon tasting, with release of pea flavor.

Step 5 relates to reducing the temperature to 50° C. after adding emulsifiers (preferably vegetable or soy lecithin and PGPR) to this same mixing bowl.

Step 6 consists in mixing to obtain a homogeneous mixture, for example for 30 minutes at 50° C.

Step 7 then relates to the tempering carried out according to conventional processes of the art, manually on marble or in a dedicated automatic device.

After tempering, the protein-enriched chocolate is introduced into molds chosen according to the desired shape and left to cool to room temperature. It can also be used in enrobing, bottom coating or for the creation of chocolate shells for chocolate candies.

The present invention will be better understood by reading the non-exhaustive examples hereinbelow.

### EXAMPLES

### Example 1

### Production of Chocolate According to the Prior Art—Milk Chocolate of the Prior Art No. 1

A classic chocolate, not enriched with protein, will serve as an organoleptic reference. Use will be made of the process entitled “CONTROL: TRADITIONAL MILK CHOCOLATE” from example 1 of application WO 2011/095740.

### Example 2

### Production of Chocolate Enriched with More than 30% Protein According to Prior Art Processes—Milk Chocolate of the Prior Art No. 2

This example proposes to produce a chocolate enriched with more than 30% protein produced according to the prior art process, i.e. by mixing all the components from the start, including proteins.

In order to produce the chocolate, the table below summarizes the ingredients used.

Dark chocolate CHD-Q11-105 is a dark chocolate produced by BARRY CALLEBAUT, containing a minimum of 54.1% of dry cocoa-derived solids.

NUTRALYS® XF is a pea protein isolate sold by Roquette containing about 85% protein. lnstantwhey (450) whey is a whey produced by Fonterra, containing 80% protein.

Noir absolu EBONY is a cocoa mass sold by Puratos, its addition enhances the chocolate flavor.

Soy lecithin is a natural emulsifier, extracted from soy.

ADMUL WOL 1403 is also an emulsifier. Produced by Kerry, it is composed of polyglycerol polyricinoleates.

| | Weight | | Composition |
|---|---|---|---|
| | (in g) | | (in %) |
| Dark chocolate (CHD-Q11-105) | 390.000 | g | 38.883 |
| NUTRALYS ® XF (ROQUETTE) | 200.000 | g | 19.940 |
| Instantwhey (450) whey | 184.000 | g | 18.345 |
| Cocoa butter | 176.500 | g | 17.597 |
| Semi-skimmed milk | 30.000 | g | 2.991 |
| Cocoa mass, Noir absolu EBONY (54% fat) | 15.000 | g | 1.496 |
| Soy lecithin | 4.500 | g | 0.449 |
| ADMUL WOL 1403 | 3.000 | g | 0.299 |

| | | |
|---|---|---|
| Total | 1003.00 | 100.000 |

Total proteins: 32%

The protocol for making this chocolate, milk chocolate of the prior art no. 2, is as follows:
1. Mixing of all the ingredients of table 1 at 40° C.
2. Grinding (on a three-roll mill): pressure of the rolls: 1st pass at 20-30 bar, 2nd pass at 35-45 bar, 3rd pass at 55-60 bar.
3. “Conching”: temperature 60° C., duration 20 h
4. Cooling to 50° C.
5. Tempering, and pouring into molds

### Example 3

### Production of Chocolate Enriched with More than 30% Protein According to the Process of the Invention—Chocolate No. 3

This example proposes to produce a chocolate enriched with more than 30% protein produced according to the process of the invention, i.e. by mixing and grinding a protein/cocoa butter mix separately, before mixing it with a chocolate made separately according to a conventional process.

The ingredients and amounts used are those already described in example 2 above.

The protocol for making this chocolate is as follows:
1. Mixing the proteins (NUTRALYS® XF and whey) with half the amount of cocoa butter at 40° C.
2. Separate mixing of the other remaining ingredients at 40° C., except for the soy lecithin and ADMUL WCL 1403 (emulsifiers)
3. Separate grinding of the two mixtures (on a three-roll mill): pressure of the rolls: 1st pass at 20-30 bar, 2nd pass at 35-45 bar, 3rd pass at 55-60 bar.
4. Separate heating or “conching” of the two mixtures at 60° C. with stirring until a homogeneous mixture is obtained, conditions used for “Conching”: temperature 60° C., duration 20 h for the second mixture and 4 h for the first containing the proteins.
5. Mixing of he two conched masses
6. Cooling to 50° C.
7. Tempering, and pouring into molds

It can already be observed that using a ready-made, and therefore already conched, chocolate instead of the second mixture, it is possible to reduce the conching time to only 4 hours.

### Example 4

### Production of Chocolate Enriched with More than 30% of Exclusively Vegetable Proteins According to Prior Art Processes—Milk Chocolate of the Prior Art No. 4

This example proposes to produce a chocolate enriched with more than 30% of exclusively vegetable proteins which is produced according to the prior art process, i.e. by mixing all the components from the start, including proteins.

In order to produce the chocolate, the table below summarizes the ingredients used.

Dark chocolate CHD-Q11-105 is a dark chocolate produced by BARRY CALLEBAUT, containing a minimum of 54.1% of dry cocoa-derived solids.

NUTRALYS® S85Plus-N is a pea protein isolate sold by Roquette containing about 85% protein.

lnstantwhey (450) whey is a whey produced by Fonterra, containing 80% protein.

Noir absolu EBONY is a cocoa mass sold by Puratos, its addition enhances the chocolate flavor.

Soy lecithin is a natural emulsifier, extracted from soy.

ADMUL WOL 1403 is also an emulsifier. Produced by Kerry, it is composed of polyglycerol polyricinoleates.

| | Weight | Composition |
|---|---|---|
| | (in g) | (in %) |
| Dark chocolate (CHD-Q11-105) | 476.7 | 47.67 |
| NUTRALYS ® S85PluS-N (ROQUETTE) | 339.0 | 33.90 |
| Cocoa butter | 164 | 16.4 |
| Cocoa mass, Noir absolu EBONY (54% fat) | 15.4 | 1.54 |
| Soy lecithin | 4.7 | 0.47 |
| Total | 999.8 | 100.0 |

Total proteins: 33.9%

The protocol for making this chocolate (milk chocolate of the prior art no. 4) is as follows:
1. Mixing of all the ingredients of table 1 at 40° C.
2. Grinding (on a three-roll mill): pressure of therolls: 1st pass at 20-30 bar, 2nd pass at 35-45 bar, 3rd pass at 55-60 bar,
3. “Conching”: temperature 60° C., duration 20 h
4. Cooling to 50° C.
5. Tempering, and pouring into molds

### Example 5

### Production of Chocolate Enriched with More than 30% of Exclusively Vegetable Proteins According to the Process of the Invention—Chocolate No. 5

This example proposes to produce a chocolate enriched with more than 30% of exclusively vegetable proteins produced according to the process of the invention, i.e. by mixing and grinding a protein/cocoa butter mix separately, before mixing it with a chocolate made separately according to a conventional process.

The ingredients and amounts used are those already described in example 4 above.

The protocol for making this chocolate (chocolate no. 5) is as follows:
1. Mixing the protein (NUTRALYS® 385plus-N) with half the amount of cocoa butter at 40° C.
2. Separate mixing of the other remaining ingredients at 40° C., except for the soy lecithin
3. Separate grinding of the two mixtures (on a three-roll mill): pressure of the rolls: 1st pass at 20-30 bar, 2nd pass at 35-45 bar, 3rd pass at 55-60 bar.
4. Separate heating or “conching” of the two mixtures at 60° C. with stirring until a homogeneous mixture is obtained, conditions used for “Conching”: temperature 60° C., duration 20 h for the second mixture and 4 h for the first containing the proteins.
5. Mixing of the two conched masses
6. Cooling to 50° C.
7. Tempering, and pouring into molds

It can already be observed that using a ready-made, and therefore already conched, chocolate instead of the second mixture, it is possible to reduce the conching time to only 4 hours.

### Example 6

### Comparison of the Chocolates Obtained in the Examples Above

The five samples of “milk” chocolate, the reference (no. 1), two products according to a prior art process (no. 2 and no. 4) and two with a process according to the invention (no. 3 and no. 5), were tasted blind by a 20-person panel of experts in sensory testing. A commercial protein-enriched chocolate, MyProtein®, enriched with 20% protein, is also tested.

The first test consisted of a triangular test in which, of the three samples proposed, two were identical.

83% of the people who took part in the test could not distinguish any difference between chocolate 1 (reference, low in protein) and 3 (invention, protein-enriched).

The second test, still carried out blind, consisted in tasting the five samples and in describing them.

Tasting is an operation which consists in testing, analyzing and assessing the organoleptic characteristics and more particularly the organo-olfactory characteristics of a product. Tasting calls upon the visual, tactile, olfactory and gustatory senses. For this tasting, the qualifiers used were identical for the chocolates according to the prior art or according to the invention (chocolates 1 to 5):
1. Observation test: surface of the chocolate smooth, moire and slightly glossy.
2. Tactile test: smooth, hard surface.
3. Olfactory test: sweet, fruity, very pleasant odor.
4. Gustatory test: smoothness, roundness in the mouth, creamy, absence of grittiness, melt-in-the-mouth.

These various sensory analysis tests perfectly demonstrate that the trained panel was unable to differentiate between the reference chocolate (no. 1) and the protein-enriched chocolates obtained with a process according to the invention (no. 3 and no. 5). However, a gritty appearance was noted for the chocolates obtained with a process according to the prior art (no. 2 and no. 4) and the commercial chocolate MyProtein®. The advantage of the invention is therefore demonstrated.

This invention will in particular enable people who are allergic to milk proteins to enjoy chocolates that are as good and smooth as their equivalents. This chocolate is also of benefit to people doing intensive sports or seeking to reduce the intake of sugar and fat.

The present example further shows that protein enrichment is possible. Thus chocolates no. 3 and no. 5 contain more protein than the control chocolate, and the statement “source of protein”, or even “rich in protein”, may be indicated on its packaging.

The invention is also advantageous from a rheological point of view. Specifically, viscosity is a critical factor among chocolate manufacturers.

Viscosity measurements were carried out at 40° C. on a Physica MCR 301 rheometer according to the current standard for chocolate manufacturers (AIOCC standard).

Device used: Imposed strain rheometer (PHYSICAC, 10 MCR301-Anton Paar) with coaxial cylinder (external diameter 34 mm, internal diameter 32 mm) geometry
Temperature: 40° C.
Pre-shear: 10 min at 5 s⁻¹
Shear gradient: 1 to 50 s⁻¹ in 3 min
Shear hold: 1 min at 50 s⁻¹
Shear descent: 50 to 1 s⁻¹ in 3 min

The results are expressed after modeling, according to the Casson method, of the return curve (shear descent). This methodology meets the requirement of the ICA 46 standard.

The table below presents the Casson viscosity (Pa·$) and the yield point (Pa).

| | Viscosity | Yield |
|---|---|---|
| | (Pa · s) | point (Pa) |
| Commercial 20%-protein-enriched chocolate (MyProtein ®) | 6.9 | 38.4 |
| Chocolate according to the prior art (example 1) | 1.5 | 6.8 |
| Protein-enriched chocolate, produced according to the prior art | 8.6 | 2.9 |
| (example 2, chocolate no. 2) | | |
| Protein-enriched chocolate, produced according to the invention | 3.98 | 15 |
| (example 3, chocolate no. 3) | | |
| Chocolate enriched with exclusively vegetable proteins, produced | 7 | 48 |
| according to the prior art (example 4, chocolate no. 4) | | |
| Chocolate enriched with exclusively vegetable proteins, produced | 5.8 | 29 |
| according to the invention (example 5, chocolate no. 5) | | |

The table above clearly shows that the viscosity of the chocolate according to the invention is closer to the chocolate according to prior art no. 1. It is therefore easier for the chocolate maker to handle the mass during the process.

1. A protein-enriched chocolate, comprising between 20% and 40%, preferentially between 25% and 35% of proteins, preferentially of vegetable proteins, more preferentially still of pea proteins, the % being expressed by dry weight relative to the total dry weight of the protein-enriched chocolate.

2. The protein-enriched chocolate as claimed in claim 1, Casson viscosity less than 6 Pa·s, more particularly between 1 and 6 Pa·s, preferentially between 3 and 6 Pa·s.

3. The protein-enriched chocolate as claimed in claim 1, only vegetable proteins, more preferentially still only pea proteins.

4. The protein-enriched chocolate as claimed in claim 1, wherein said proteins is a mixture of vegetable proteins and animal proteins, preferentially proteins of dairy origin.

5. A process for preparing the protein-enriched chocolate as claimed in claim 1, steps of:
a. producing a first mixture composed
i. of a portion of the total amount of the cocoa butter used in the process,
ii. and of an amount of proteins so as to obtain a final content of proteins between 20% and 40%, preferentially between 25% and 35% by dry weight relative to the total dry weight of the protein-enriched chocolate;-;
b. grinding the first mixture by passing through a mill suitable for refining chocolate, preferentially a two- or three-roll apparatus
c. producing a second mixture composed
i. of an amount of chocolate representing between 30% and 50%, preferentially between 35% and 45% by dry weight relative to the total dry weight of the protein-enriched chocolate
ii. and of the remaining amount of the cocoa butter, after using the amount from step a;
d. heating the two mixtures to about 60° C. so as to obtain the melting of the mixtures, two homogeneous mixtures,
e. intimately mixing the two mixtures at 60° C., preferentially for a time of between 1 hour and 5 hours, more preferentially of between 2 h and 4 h, more preferentially still for 3.5 hours,
f. cooling the temperature of the mixture obtained in step e to 50° C. and adding one or more emulsifiers, preferentially vegetable lecithin,
g. tempering the mixture;
h. pouring the mixture into the molds.
wherein the total amount of cocoa butter being between 5% and 20%, preferentially between 8% and 17%, by dry weight relative to the total dry weight of the protein-enriched chocolate.
